(19) United States
(12) Patent Application Publication
(10) Pub. No.: US 2015/0203009 A1
(43) Pub. Date: Jul. 23, 2015

(54) HEAD STABILIZING STRAP ASSEMBLY

(71) Applicant: BONNIE MARTHA SWEARINGEN, SUISUN CITY, CA (US)

(72) Inventor: BONNIE MARTHA SWEARINGEN, SUISUN CITY, CA (US)

(21) Appl. No.: 14/157,876

(22) Filed: Jan. 17, 2014

(51) Int. Cl. B60N 2/48; B60R 22/00

(52) U.S. Cl. CPC B60N 2/4879; B60R 22/001

(57) ABSTRACT

Some embodiments of the present invention include a system for holding a user's head upright and in place, the system including a seat strap, a chin strap, and a forehead strap. The seat strap may be configured to fit around the circumference of a seat's headrest. The chin strap may be padded and have a central portion, a distal end, and a proximal end. The distal end and the proximal end may be spaced apart and removably attached to the seat strap by a fastener. The chin strap may be adjustable and configured to fit around a user's chin. The forehead strap may be attached to the seat strap between the proximal end of the chin strap and the distal end of the seat strap. The forehead strap may be adjustable and configured to fit around a circumference of the user's forehead.

### BACKGROUND

The embodiments herein relate generally to traveling accessories and, more particularly, to an assembly system for stabilizing a person's head when the person is traveling.

Today's society is a very mobile society. People are constantly traveling from one location to another by train, plane, and automobile. Oftentimes people fall asleep while traveling, which is particularly desirable on long trips. However, some people have trouble falling asleep because the movement of the vehicle causes their heads to also move. For example, when on a plane, a passenger may wish to sleep, but may not be able to due to their head not being kept upright and still due to the turbulence or other movements that are associated with flying.

Many travelers now lean against a door or window to prop their heads up to be comfortable enough to sleep. Some travelers use pillows, particularly neck pillows, which wrap around a users neck. However, these neck pillows do not keep a user's head upright or in place. Rather, movement of the head is still possible even when a traveler is using a head pillow.

Therefore, what is needed is a system that keeps a user's head in an upright position and in place to aid a user in getting sleep while traveling.

### SUMMARY

Some embodiments of the present invention include a system for holding a user's head upright and in place, the system including a seat strap, a chin strap, and a forehead strap. The seat strap may be configured to fit around the circumference of a seat's headrest. The chin strap may be padded and have a central portion, a distal end, and a proximal end. The distal end and the proximal end may be spaced apart and removably attached to the seat strap by a fastener. The chin strap may be adjustable and configured to fit around a user's chin. The forehead strap may be attached to the seat strap between the proximal end of the chin strap and the distal end of the seat strap. The forehead strap may be adjustable and configured to fit around a circumference of the user's forehead.

### BRIEF DESCRIPTION OF THE FIGURES

The detailed description of some embodiments of the invention is made below with reference to the accompanying figures, wherein like numerals represent corresponding parts of the figures.

FIG. 1 is a front view of one embodiment of the present invention in use.

FIG. 2 is a left perspective view of one embodiment of the present invention.

FIG. 3 is a side view of one embodiment of the present invention in use.

FIG. 4 is a right perspective view of one embodiment of the present invention.

### DETAILED DESCRIPTION OF CERTAIN EMBODIMENTS

In the following detailed description of the invention, numerous details, examples, and embodiments of the invention are described. However, it will be clear and apparent to one skilled in the art that the invention is not limited to the embodiments set forth and that the invention can be adapted for any of several applications.

The system of the present disclosure may be used to keep a user's head upright and in place while traveling and may comprise the following elements. This list of possible constituent elements is intended to be exemplary only, and it is not intended that this list be used to limit the system of the present application to just these elements. Persons having ordinary skill in the art relevant to the present disclosure may understand there to be equivalent elements that may be substituted within the present disclosure without changing the essential function or operation of the system.
1. Forehead Strap
2. Seat Strap
3. Chin Strap
4. Connectors

The various elements of the system for keeping a user's head upright and in place may be related in the following exemplary fashion. It is not intended to limit the scope or nature of the relationships between the various elements and the following examples are presented as illustrative examples only.

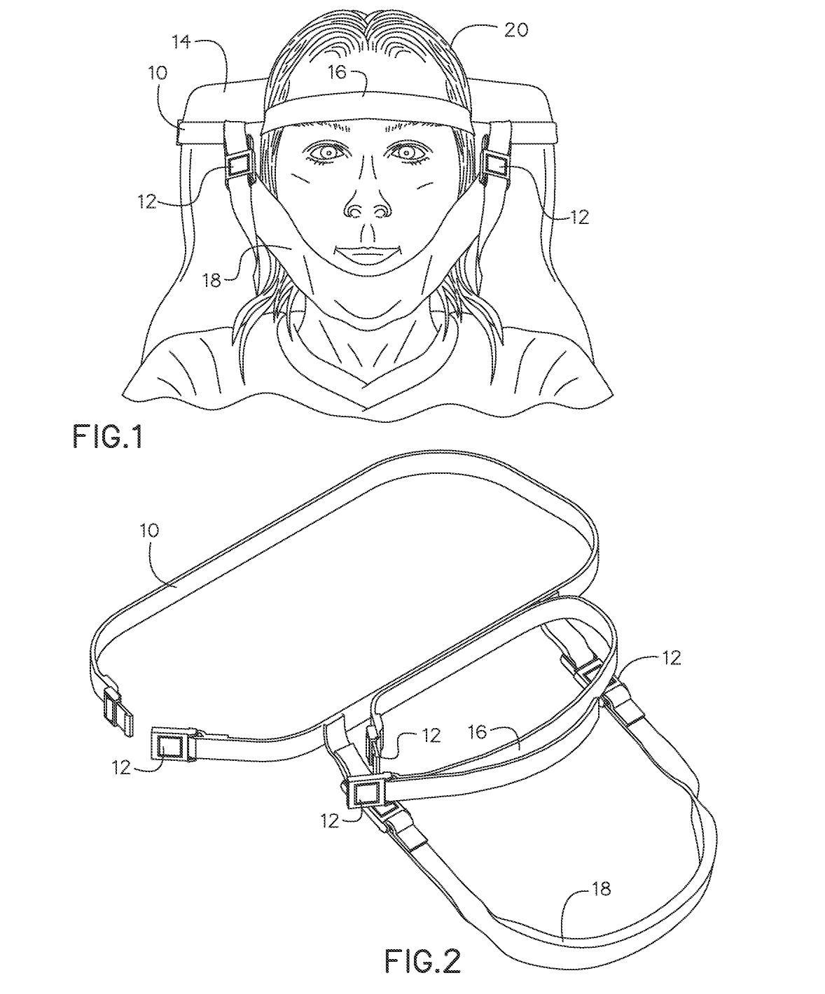

By way of example, and referring to FIGS. 1-4, one embodiment of the present invention comprises an assembly comprising a seat strap 10 configured to fit around the circumference of a headrest 14 of a seat, such as a seat in a vehicle, a forehead strap 16 attached to the seat strap 10, the forehead strap 16 being configured to fit around the circumference of a user's head 20, and a chin strap 18 attached to the seat strap 10, the chin strap 18 being configured to wrap around the jaw line of a user's face, holding the user's chin in place. In embodiments, the seat strap 10 may have a proximal end and a distal end, the distal end and the proximal end being connected by a fastener 12, such as a clip, a snap, a button, a hook and loop fastener, such as VELCRO, or any other conventional fastener. In embodiments, the fastener 12 may also function as an adjuster, or alternatively, the seat strap 10 may also comprise an adjuster, allowing a user to tighten or loosen the seat strap 10 around the headrest 14 as needed. In other embodiments, the seat strap 10 is a solid strap that slips around a headrest 14.

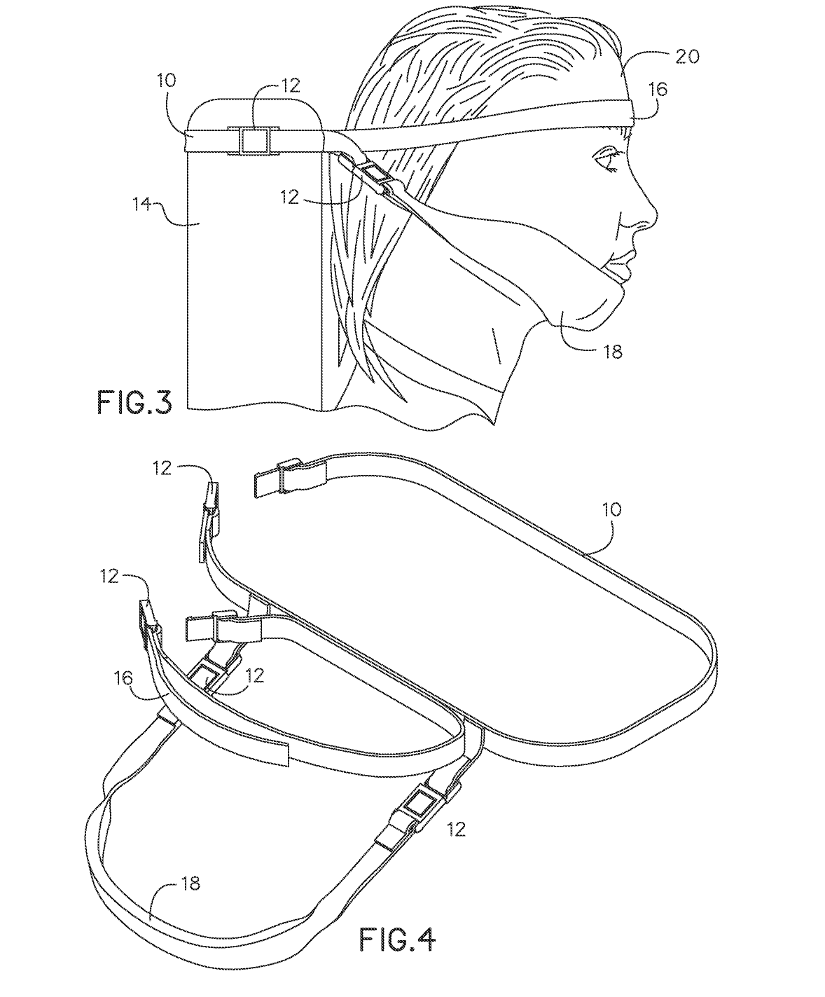

In embodiments, and as shown in FIGS. 1-4, the chin strap 18 may comprise a central portion, a distal end, and a proximal end, each of the ends being attached to the seat strap 10 and spaced apart from one another. At least one of the distal end and the proximal end of the chin strap 18 may be attached to the seat strap 10 using a fastener 12. The other end may be permanently attached to the seat strap 10 or attached to the seat strap 10 using a fastener 12. As with the seat strap 10, the fastener 12 may also function as an adjuster or, alternatively, the chin strap 18 may also comprise an adjuster, allowing a user to tighten or loosen the chin strap 18 as needed to fit the user's chin comfortably. In embodiments, the central portion of the chin strap 18 may be padded to increase comfort of a user. When in use, the chin strap 18 supports the chin of a user, as shown in FIGS. 1 and 3.

In embodiments, and as shown in FIGS. 1-4, the forehead strap 16 may be attached to the seat strap 10, such that the portion of the forehead strap 16 that is attached to the seat strap 10 is positioned in between the distal end and the proximal end of the chin strap 18. In embodiments, the forehead strap 16 may have a first end and a second end, which attach to one another using a fastener 12. Similar to the seat strap 10 and the chin strap 18, the fastener 12 of the forehead strap 16 may also function as an adjuster or, alternatively, the forehead strap 16 may also comprise an adjuster, allowing a user to tighten or loosen the forehead strap 16 as needed. When in use, the forehead strap 16 straps a user's head 20 to the headrest 14, holding the user's head 20 in place and preventing the user's head from falling to the left, to the right, or forward.

Each of the seat strap 10, the chin strap 18, and the forehead strap 16 may be made of any suitable material. In embodiments, suitable materials include elastic and non-elastic materials. The forehead strap 16 and the chin strap 18 may be made from padded materials to increase the comfort of a user.

To use the head stabilizing assembly, a user would position the seat strap 10 around a head rest 14 and tighten the seat strap, if necessary. For example, the user may position the seat strap 10 around the head rest 14 of any type of seat, such as an airplane seat, a seat in a car, a train seat, a chair, a chasse lounge, a wheelchair, or any other conventional In embodiments, the head stabilizing assembly is designed not to block a television in the back of the headrest, as in many airplane and car headrests. The user would also strap the forehead strap around their forehead and connect the first and second ends using the fastener. The user may then position the chin strap across their chin and connect the proximal and distal ends to the seat strap using the fasteners. The chin strap may aid in keeping the user's head in place and may also prevent a user's mouth from opening during sleep.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for holding a user's head upright and in place, the system comprising:
a seat strap configured to fit around a circumference of a headrest;
a chin strap comprising a central portion, a distal end, and a proximal end, each of the distal end and the proximal end being attached to the seat strap, the chin strap being configured to fit around the user's chin, and the distal end and the proximal end being spaced apart;
a forehead strap attached to the seat strap, the forehead strap configured to fit around a circumference of the user's forehead.

2. The system of claim 1, wherein the seat strap comprises a distal end and a proximal end, the distal end of the seat strap and the proximal end of the seat strap being attached by a fastener.

3. The system of claim 1, wherein a length of the seat strap is adjustable.

4. The system of claim 1, wherein the central portion of the chin strap is made of a padded material.

5. The system of claim 1, wherein at least one of the distal end of the chin strap and the proximal end of the chin strap is removably attached to the seat strap by a fastener.

6. The system of claim 5, wherein each of the distal end of the chin strap and the proximal end of the chin strap is removably attached to the seat strap by a fastener.

7. The system of claim 1, wherein a length of the chin strap is adjustable.

8. The system of claim 1, wherein the forehead strap has a first end and a second end, the first end and the second end being attached by a fastener.

9. The system of claim 1, wherein a length of the forehead strap is adjustable.

10. A system for holding a user's head upright and in place, the system comprising:
a seat strap configured to fit around the circumference of a headrest of a seat in a vehicle;
a padded chin strap comprising a central portion, a distal end, and a proximal end, the distal end and the proximal end being each being spaced apart and removably attached to the seat strap by a fastener, the chin strap being adjustable and configured to fit around a user's chin; and
a forehead strap attached to the seat strap between the proximal end of the chin strap and the distal end of the seat strap, the forehead strap being adjustable and configured to fit around a circumference of the user's forehead.
